(19) United States
(12) Patent Application Publication
(10) Pub. No.: US 2025/0148765 A1
(43) Pub. Date: May 8, 2025

(54) ANNOTATING IMAGES FOR TRAINING COMPUTER VISION MODELS

(71) Applicant: Microsoft Technology Licensing, LLC, Redmond, WA (US)

(72) Inventors: Lu YUAN, Redmond, WA (US); Bin XIAO, Sammamish, WA (US); Haiping WU, Burnaby (CA); Weijian XU, Sammamish, WA (US); Xiyang DAI, Bellevue, WA (US); Houdong HU, Kirkland, WA (US); Yumao LU, Bellevue, WA (US); Nanshan ZENG, Bellevue, WA (US); Ce Christopher LIU, Belmont, MA (US)

(73) Assignee: Microsoft Technology Licensing, LLC, Redmond, WA (US)

(21) Appl. No.: 18/427,493

(22) Filed: Jan. 30, 2024

Related U.S. Application Data
(60) Provisional application No. 63/596,577, filed on Nov. 6, 2023.

(51) Int. Cl. G06V 10/774; G06F 40/284; G06V 20/40

(52) U.S. Cl. CPC G06V 10/774; G06F 40/284; G06V 20/41; G06V 2201/07

(57) ABSTRACT

A method for annotating images to create a corpus for training a multi-task computer vision machine learning model is presented. The method comprises receiving, at one or more annotation specialist models, a plurality of images to be annotated. Via operation of the one or more annotation specialist models, pre-filtered annotations are generated for the plurality of images. Via operation of a data filtering and enhancement module, the pre-filtered annotations are filtered in accordance with predefined noise criteria so as to output candidate annotations for the plurality of images. The method further comprises, for each of one or more candidate annotations, selectively (1) storing the candidate annotation into the corpus as a final annotation for its associated image, or (2) adding the candidate annotation to its associated image using the one or more annotation specialist models and the data filtering and enhancement module for subsequent iterative annotation and filtering.

### CROSS REFERENCE TO RELATED APPLICATIONS

This application claims priority to U.S. Provisional Patent Application Ser. No. 63/596,577, entitled “METHOD FOR ANNOTATING IMAGES FOR COMPUTER VISION”, filed Nov. 6, 2023, the entirety of which is hereby incorporated herein by reference for all purposes.

### BACKGROUND

Recent years have seen a noticeable shift towards utilizing pre-trained, versatile representations in the realm of Artificial Intelligence systems. These representations are increasingly used in a task-agnostic manner to facilitate various downstream tasks, particularly in the field of natural language processing (NLP). Cutting-edge models demonstrate their adaptability to a wide array of tasks using multi-task, large scale models, thanks to their comprehensive knowledge spanning various domains and tasks.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A method for annotating images to create a corpus for training a multi-task machine learning computer vision model is presented. The method comprises receiving, at one or more annotation specialist models, a plurality of images to be annotated. The method further comprises, via operation of the one or more annotation specialist models, generating pre-filtered annotations for the plurality of images. The method further comprises, via operation of a data filtering and enhancement module, filtering the pre-filtered annotations in accordance with predefined noise criteria so as to output candidate annotations for the plurality of images. The method further comprises, for each of one or more candidate annotations, selectively (1) storing the candidate annotation into the corpus as a final annotation for its associated image, or (2) adding the candidate annotation to its associated image using the suite of specialist models and the data filtering and enhancement module for subsequent iterative annotation and filtering.

### BRIEF DESCRIPTION OF THE DRAWINGS

FIG. 1 shows an example unified vision foundation model.

FIG. 2 shows a workflow for a vision foundation model data engine.

FIG. 3 shows a flow-diagram for an example method for annotating images to create a corpus for training a foundation computer vision model.

FIG. 4 illustrates example image annotations.

FIGS. 5A-5D shows example distribution plots for bounding boxes.

FIG. 6 shows an implementation of a vision foundation model comprising an image encoder and a multi-modality encoder-decoder.

FIG. 7 shows a flow-diagram for an example method for computer vision task formulation.

FIGS. 8A-8C shows plots illustrating training efficiency.

FIGS. 9A-9D show plots illustrating multi-task transfer with differently trained models.

FIG. 10 schematically shows an example computing system.

### DETAILED DESCRIPTION

One pioneering model in computer vision, Florence-1, strived to seamlessly integrate spatial, temporal, and multimodal aspects within the realm of computer vision through unified pre-training and network architecture. Florence-1 was pre-trained with noisy text-image pairs and finetuned for different tasks using adapters, excelling in transfer learning scenarios. While not entirely task-agnostic, this approach sometimes demands task-specific fine-tuning datasets with thousands or millions of examples. In contrast, models like GPT-3/4, powerful language foundation models, excel at performing various and even new language tasks with simple instructions, which is a capability that current vision systems struggle to achieve.

First, the absence of comprehensive visual annotated data presents an obstacle to the development of a foundational model capable of capturing the intricate nuances of spatial hierarchy, progressive granularity, and the semantic spectrum. Many established datasets and annotations tend to serve specific, specialized purposes. For example, ImageNet supplies classification tags, COCO furnishes object detection bounding box and segmentation mask labels, and Flickr30k Entities delivers visual grounding annotations. This prompts the question: “How can one create a dataset with comprehensive visual annotations at scale?” Each image is tagged with “comprehensive annotations” that encompass all three intricate nuances, which are helpful for acquiring a versatile visual representation.

As widely known, complete understanding of visual scenes is an inherent goal of computer vision, and it relies on the comprehensive annotations from vision datasets. Early dataset creators attempted to complete the visual understanding in multiple individual datasets where each target at one perspective, e.g., image classification. Recent progress on vision datasets has shifted from single to multiple perspectives, providing comprehensive annotations for every visual data point. Notably, MS-COCO integrates image, object, and pixel-level annotations; Visual Genome further introduces object attributes and relations within a formalized scene graph structure. These comprehensive annotations enable richer understanding in various spatial and semantic granularities and better model interactions across annotations. However, the human-verified comprehensive annotations are limited in size due to the high cost of labeling efforts. The datasets disclosed herein follow the paradigm with comprehensive image annotations that cover text, region-text pairs, and text-phrase-region triplets, while being large-scale with reduced human involvement.

In the past decade, vision datasets are scaled up rapidly from thousands to billions of examples to encompass more visual concepts for better generalization. Especially, the recent foundation models signal a paradigm shift in dataset building where increasingly massive quantities of data are employed in training. These huge datasets typically collect a large scale of images from various sources using search engines, and parse noisy annotations from the corresponding meta-data, such as category labels from query, short descriptions from alt-text, as well as detailed descriptions from interleaved text. These parsed annotations have great diversity, but they suffer from a high ratio of randomness and limited annotation types (e.g., texts). Alternatively, several works attempt to scale up the annotations by pseudo-label generation with iteratively trained models. The synthetic annotation from models has higher quality without significant diversity loss. The disclosed data pipeline is based on the large-scale noisy annotations but extends them with human-annotated datasets with increased quality. Importantly, pseudo-label generation from multiple annotation specialists are adopted to refine the labels and complete the missing pieces for comprehensive annotations, resulting in a scalable and comprehensive dataset for the disclosed unified visual representation.

Recent vision-language pre-training models trained on large-scale image-text data have shown impressive zero-shot transfer abilities to vision-language alignment and image classification tasks. Vision embeddings extracted from vision encoder and text embeddings extracted from text encoder are aligned with contrastive learning objectives. This further demonstrates the power of such a pre-training scheme to transfer to more downstream tasks (such as object detection) and achieves state-of-the-art performance with task-specific adaptation heads.

Differently, other approaches propose to use multi-modality decoder to predict text in an autoregressive manner with language modeling pre-training objectives. In order to fuse vision and language embeddings, another approach directly concatenates vision tokens and text tokens together as input to decoder and designs a casual attention mask such that vision tokens can attend each other and text tokens can only attend their preceding tokens and all vision tokens. Another approach adapts attentional poolers with learnable queries to select task-specific vision representations, then the pooled embeddings are cross-attended via the decoder. One present technology, Flamingo, pools a fixed number of vision tokens with an adapted Transformer model and adds new learnable cross-attention layers to the decoder to attend vision tokens while freezing the pre-trained vision encoder and text decoder.

Besides the image captioning pre-training task, other approaches formulate more vision tasks in a unified sequence-to-sequence learning paradigm, including object detection and image segmentation. Customized special tokens are designed to accommodate representations beyond pure text (e.g., bounding boxes). This sequence-to-sequence learning formulation allows using the same architecture for pre-training and downstream tasks. The disclosed method falls into this category as a target to obtain multi-task large scale models that understand dense information beyond simple image-level captions of the visual signals. The present technology uses multi-modality encoder-decoder models for sequence-to-sequence learning. The disclosed method uses the same encoder-decoder design but equips with the large-scale dense descriptions data instead of combining existing sparse annotated data together.

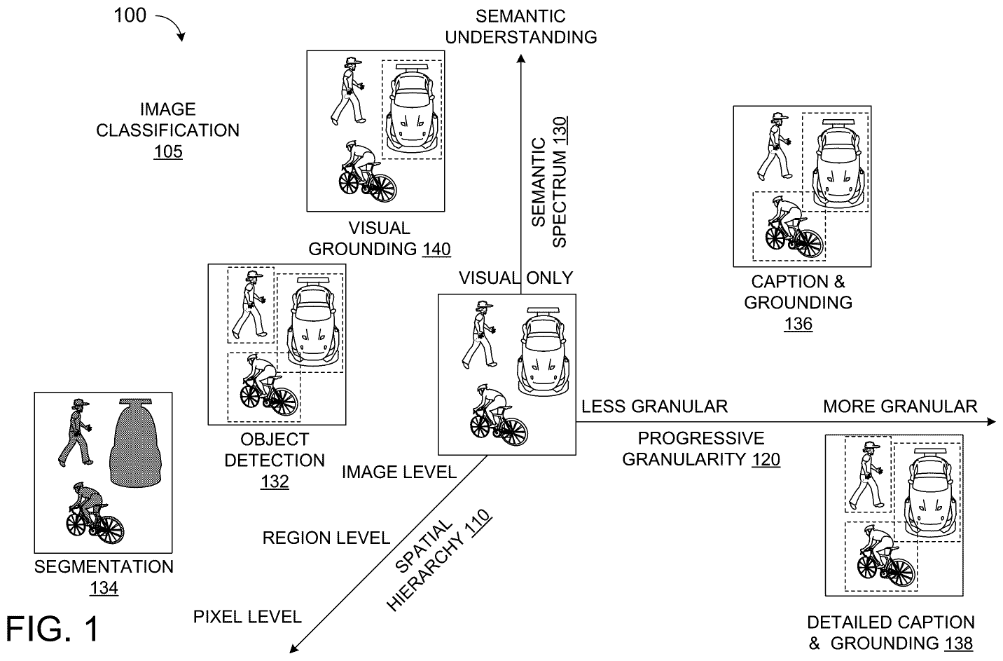

FIG. 1 illustrates some of the main challenges 100 stemming from a vision system's requirement to offer extensive perception capabilities for downstream tasks of image classification 105. Such tasks include spatial hierarchy 110, progressive granularity 120, and semantic spectrum 130.

Within spatial hierarchy 110, the model seeks to grasp spatial details at different scales, ranging from less granular, image-level concepts to fine-grained pixel-level specifics. Information may cover basic image level classification, such as identifying scenery, a car, cyclist, and pedestrian. At the region level, object detection 132 is performed, positioning bounding boxes for each detected object. Each object may have an associated caption or description. At the pixel level, image segmentation 134 is performed, segmenting the image into detailed masks and aligning the perception information with the image data.

For progressive granularity 120, the model seeks to transition from brief captions to in-depth, nuanced descriptions, allowing for a wide range of granularity in comprehension. This may include basic image level classification information with simple words or short sentences through basic captioning and grounding 136, through detailed captioning and grounding 138, which may include paragraph-length textual information. Grounding allows for the captioning to be associated with localization of objects, bounding boxes, and masks within the image, rather than just with the image as a whole.

For semantic spectrum 130, the model's understanding can go beyond mere object recognition, encompassing the nuanced and multifaceted semantics of images and objects. This may include associating captions with image portions via progressively more discrete visual grounding 140.

These challenges faced by computer vision models are a consequence of limited training data with comprehensive annotations. The inventors recognize that another problem is the absence of a single unified network architecture capable of simultaneously addressing multiple computer vision tasks in the same representations within the same framework or pipeline.

Herein, an example of such a unified multi-task computer vision machine learning model is presented (referred to herein as the disclosed adaptable large-scale computer vision machine learning model (ALS-CV-MLM)), a universal backbone created through multitask learning using a vast repository of comprehensive visual annotated data, resulting in a shared representation. This universal representation serves as the foundation for accommodating a wide range of computer vision tasks within a single model, governed by a uniform set of parameters. A diverse array of tasks, including, but not limited to, classification, object detection, captioning, and grounding, can be triggered through textual prompts, emulating the approach popularized by Large Language Models (LLMs). Moreover, the disclosed methodology seamlessly allows for the integration of supplementary modules, such as decoders, into the frozen backbones, thereby expanding the system's capabilities.

One contribution of the disclosed ALS-CV-MLM lies in its effective solution to the aforementioned challenges, namely, the scarcity of comprehensive data. A unified architecture brings additional benefits. This disclosure presents a multi-task computer vision machine learning model to enable extensive perception capabilities including spatial hierarchy, progressive granularity, and semantic spectrum. To achieve this, a single unified model, the disclosed ALS-CV-MLM, is pre-trained on a dataset referred to as FLD-5B, encompassing a total of 5.3B comprehensive annotations and 126M images, which is collected by a data engine.

One challenge in the domain of data revolves around the creation of comprehensive datasets for visual comprehension in an efficient manner. This task is highly resource-intensive when conducted manually. The disclosed data engine tackles this problem by providing two highly effective processing modules. The initial module employs specialized annotation models to collaboratively and automatically annotate images, departing from the conventional single and manual annotation approach. Multiple models work together to establish a consensus, reminiscent of the wisdom-of-crowds concept, thereby ensuring a more reliable and unbiased representation of images. The second module further iteratively refines and filters these automated annotations using the disclosed ALS-CV-MLM. Through this approach, a dataset referred to as FLD-5B is constructed, encompassing a total of 5.3B annotations for 126M images.

In the realm of modeling, the disclosed approach employs a sequence-to-sequence (seq2seq) methodology comprising an image encoder and a multimodality encoder-decoder. This approach seamlessly works across a range of vision tasks without any task-specific architectural modifications. The disclosed ALS-CV-MLM is trained on a comprehensive dataset, with all annotations standardized as text outputs, utilizing a unified multi-task learning paradigm. This results in a novel general-purpose multi-task computer vision machine learning model capable of performing various vision-related tasks.

In pursuit of a versatile multi-task computer vision machine learning model, three predominant pre-training paradigms are revisited: supervised (e.g., ImageNet classification), self-supervised (such as SimCLR, MoCo, BEIT, MAE), and weakly supervised (represented by models like CLIP, Florence-1, SAM). While each paradigm demonstrates efficacy in capturing distinct facets of visual data, they are inherently confined to the limitations of single-task learning frameworks. Supervised pre-training excels in object recognition yet suffers from a lack of adaptability; self-supervised algorithms reveal intricate features but may focus excessively on specific attributes; and weakly supervised methods, such as CLIP, leverage unstructured textual annotations but yield only image-level understanding. To construct a multi-task computer vision machine learning model that is amenable to diverse applications, it is imperative to investigate novel pre-training strategies capable of surmounting single-task limitations and synthesizing both textual and visual semantics.

One aspect of image understanding is the ability to capture multiple levels of granularity, from global semantics to local details. Additionally, it is helpful to comprehend spatial relationships between objects and entities as well as their semantic context. To address these fundamental aspects of image understanding, an approach was designed to incorporate a diverse set of annotations effectively capturing the nuances of visual understanding and bridging the gap between vision and language understanding.

To train the disclosed ALS-CV-MLM, large-scale comprehensive multitask data was collected that covered various aspects of image data. A multitask image dataset is presented that was built for this purpose. The final dataset (referred to herein as FLD-5B) contains 126M images, 500M text annotations, 1.3B text-region pair annotations, and 3.6B text-phrase-region triplet annotations across different tasks. The annotation methods were adapted to suit different types of annotations.

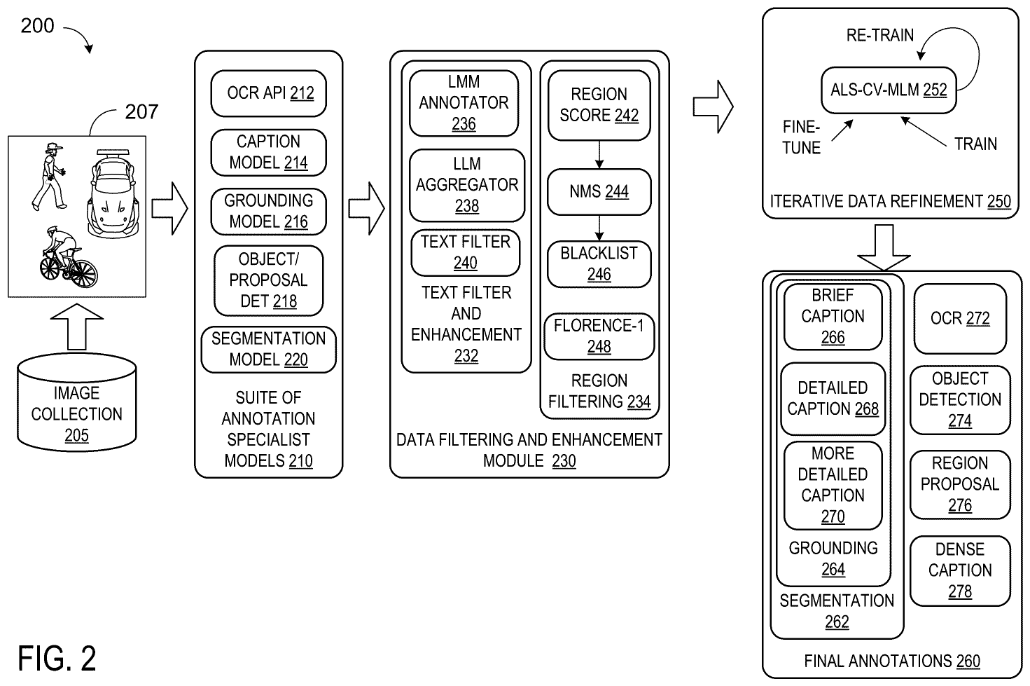

The data engine pipeline is shown in FIG. 2. As shown in FIG. 2, the disclosed ALS-CV-MLM data engine comprises three phases: (1) generating pre-filtered annotations by employing one or more annotation specialist models, (2) data filtering and enhancement to filter the pre-filtered annotations in accordance with predefined noise criteria, thus correcting errors and removing irrelevant annotations, and (3) storage of the candidate annotation and/or an iterative annotation and filtering process for data refinement. FIG. 2 depicts an example system 200 annotating images to create a corpus for training a multi-task computer vision machine learning model. System 200 comprises an image collection module 205 configured to collate a plurality of images 207. In one example, the data was constructed by gathering a diverse collection of images from various sources. This entails beginning with the identification of three key tasks that act as primary sources for the image corpus: image classification, object detection, and image captioning. Consequently, five distinct datasets originating from the aforementioned tasks were curated and combined: ImageNet-22k, Object 365, Open Images, Conceptual Captions, and LAION filtered as previously shown. This combination results in a dataset of 126 million images in total.

The data annotation workflow comprises three phases, each of which ensures the accuracy and quality of the annotations: (1) initial annotation employing annotation specialist models, (2) data filtering and enhancement to correct errors and remove irrelevant annotations, and (3) an iterative process for data refinement, annotation and filtering. In the first phase, FIG. 2 comprises a suite of annotation specialist models 210. Annotation specialist models 210 includes trained optical character recognition (OCR) application programming interface (API) 212, trained caption model 214, trained grounding model 216, trained object/proposal determination model 218, and trained segmentation model 220. Two or more models of annotation specialist models 210 may work together and collaborate with each other to perform voting and obtain pseudo-labels for the images 207.

Herein, comprehensive annotations are generated that can support multitask learning effectively. Accordingly, the annotation endeavors span a comprehensive range of tasks, encapsulated within three discrete annotation categories: text, region-text pairs, and text-phrase-region triplets. To initiate the annotation process for each annotation type, synthetic labels obtained from annotation specialist models, such as suite of annotation specialist models 210 are employed. These annotation specialist models can be a combination of offline models trained on a diverse range of publicly available datasets and online services hosted on cloud platforms. The annotation specialist models can be specifically tailored to excel in annotating their respective annotation types.

It is worth noting that certain image datasets may already contain partial annotations for some annotation types. For instance, the Object 365 dataset already includes human-annotated bounding boxes and corresponding categories as region-text annotations. In such cases, the pre-existing annotations were merged with the synthetic labels generated by the specialist models. This approach enhances the coverage and diversity of the annotations.

Moreover, specific annotations, such as detailed descriptions in the text annotation type, are represented by datasets of a considerably small size. This inherently poses challenges in obtaining high-performance specialist models. Consequently, it was opted to omit these tasks during the initial annotation phase. Annotations for these tasks are generated later during the iterative data refinement process. Through these rigorous initial annotation procedures, the aggregated dataset of images is ensured to be comprehensively labeled across the majority of annotation types.

System 200 further comprises a data filtering and enhancement module 230. Data filtering and enhancement module 230 comprises both a text filter and enhancement module 232 and a region filtering model 234. Text filter and enhancement module 232 comprises large multi-modal (LMM) annotator 236, large language model (LLM) annotator 238, and text filter 240. Region filtering module 234 comprises region score model 242, non-maximum suppression (NMS) model 244, blacklist 246, and previously trained foundation model (e.g., Florence-1) 248.

The initial annotations obtained from the annotation specialist models, while comprehensive, are susceptible to noise and imprecision. In response to this challenge, a multifaceted filtering process can be implemented to refine and eliminate undesired annotations. The general filtering protocol mainly focuses on two data types in the annotations: text and region data.

Firstly, pertaining to textual annotations, a parsing tool was developed to extract objects, attributes, and actions. Texts containing excessive objects are filtered out, as they tend to introduce noise and may not accurately reflect the actual content in the corresponding images. Additionally, the complexity of the actions and objects are assessed by measuring their degree of node in a dependency parsing tree computed by the parsing tool. Texts with a certain minimum action and object complexity are retained to ensure the richness of visual concepts in the images.

Secondly, in relation to the region annotations, specifically bounding boxes, the noisy boxes under a confidence score threshold are removed. Complementing this, non-maximum suppression is employed to reduce redundant or overlapping bounding boxes.

System 200 further comprises an iterative data refinement module 250, which employs and trains a deployable multi-task computer vision machine learning model (e.g., ALS-CV-MLM) 252. Using filtered initial annotations from data filtering and enhancement module 230, a deployable ALS-CV-MLM 252 is trained that processes sequences of data. Upon evaluating this model against the training images, a marked enhancement in its predictions can be discerned, particularly in instances where original labels were marred by inaccuracies or extraneous noise, such as in alt-texts. Motivated by these findings, these updated annotations are integrated with the original ones and the model subjected to another training iteration. This cyclical refinement process incrementally improves the quality of the training dataset, iteratively improving the model, and generating clean, high-quality labels to support multiple tasks.

In the case of tasks that were initially bypassed due to insufficient data for the training of a robust specialist model, the iteratively trained model is leveraged for pre-training purposes. Subsequent fine-tuning of this pre-trained model with the sparse dataset showcased superior performance compared to a model trained from scratch on the same data. Thus, the fine-tuned model was harnessed as a specialist for annotating the expansive dataset comprising 126 million images, ensuring comprehensive annotation coverage. This generates final annotations 260.

Final annotations 260 include annotations attached to segmentation 262 and grounding 264. Different levels of detail in final annotations 260 are provided by brief captions 266, detailed captions 268, and more detailed captions 270. Annotations may be associated with one or more of OCR 272, object detection 274, region proposals 276, and dense captioning 278. This allows for progressive granularity, wherein captions and annotations are associated with particular portions of an image.

The text annotations describe the image using descriptive text. In the text annotation type, there are tree annotations that describe the image in different granularity and styles: brief caption 266, detailed caption 268, and more detailed caption 270. The brief caption 266 may include only one sentence that demonstrates the most salient objects and activities. In contrast, the detailed caption 268 and more detailed caption 270 may contain multiple sentences that describe the image with richer objects, attributes, and actions.

In the initial annotation for brief captions 266, the seq2seq model can be trained on public-available image caption and image-text datasets and the resulting image-to-text model can be used as the specialist. The iterative refinement is conducted for several rounds to reduce the noise of the brief captions. For detailed and more detailed captions, multiple existing annotations of the image (e.g., brief caption, region-text annotations, etc.) are fed as the prompt for large language models (LLMs) to generate a comprehensive description. Due to the high cost of LLMs, a small set of detailed and more detailed captions are generated. This finetunes the caption specialist on the small training set to obtain the detailed description specialist for further annotations.

The region-text pairs provide descriptive textual annotation for semantic regions in the image. The semantic regions include regions of visual objects as well as the text regions. The region is represented by a tight bounding box surrounding the region. Moreover, each region can be annotated with varying degrees of granularity: a word, a noun phrase, or a sentence, enriching the understanding of the regions.

As the region-text pairs cover both text regions and regions of visual objects, there are two separate annotation procedures for these two types of regions respectively. For the text regions, an OCR API 212 may be relied on as the specialist to label the images. For the regions of visual objects, an object detector 218 was trained on public object detection datasets and used as a specialist for initial annotation. Any suitable object detector can be used such as Detection Transformer (DETR) with Improved DeNoising Anchor Boxes (DINO) or other DETR based detectors. Data filtering was then performed to remove noisy boxes with confidence score thresholding and non-maximum suppression. To enrich the textual annotations, the image-to-text model mentioned above was further utilized on the regions cropped from image to generate brief captions. After the enrichment, each region will have three sources of textual annotations, object category, brief caption, and noun phrase chunks extracted from the brief captions. The Florence-1 model 248 was used to measure the similarity between each textual annotation and the image region and the one with the highest similarity kept.

The text-phrase-region triplets contain three components: a text describing the image, multiple noun phrases in the text referring to the objects in the image, and the region annotations that localize the objects referred to by the noun phrases. Text annotations generated above were reused as the text in the triplets, including both the brief caption and detailed caption. For each text annotation, an off-the-shelf Grounding DINO model can be used as the specialist to extract the noun phrases and generate corresponding bounding boxes. In addition to using the boxes to localize the objects, segmentation was further generated with a SAM model 220 for each box that provides a more precise location. In the data filtering step, a confidence score threshold was applied on both noun phrases and bounding boxes to cover meaningful objects. A blacklist 246 was introduced to remove unwanted noun phrases such as pronouns and abstract concepts.

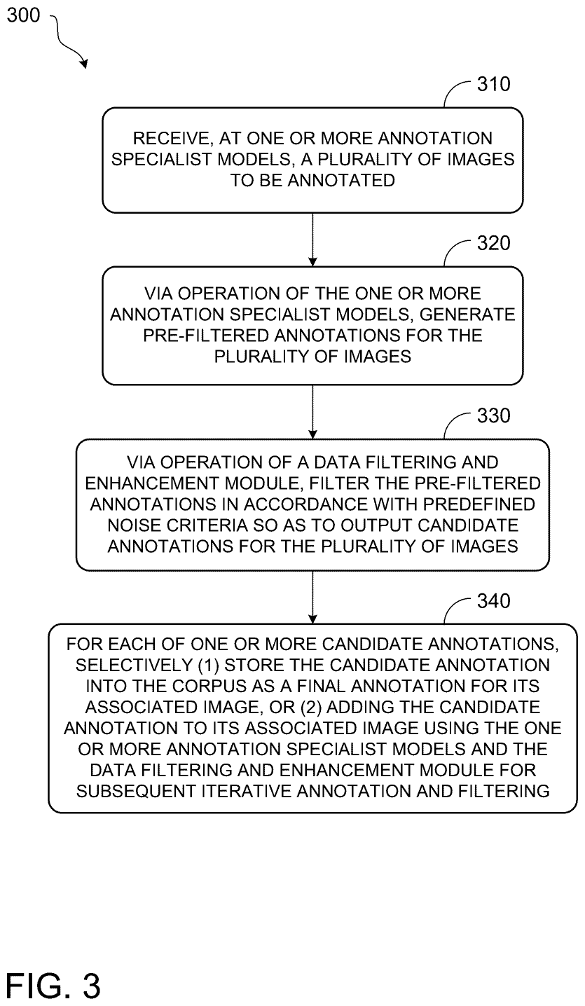

FIG. 3 depicts a flow-diagram for an example method 300 for annotating images to create a corpus for training a multi-task computer vision machine learning model. Method 300 may be performed by one or more computing systems, such as system 200.

At 310, method 300 comprises receiving, at one or more annotation specialist models, a plurality of images to be annotated. At 320, method 300 comprises, via operation of the one or more annotation specialist models, generating pre-filtered annotations for the plurality of images. The annotation specialist models may include one or more of a (1) trained caption model; (2) trained grounding model; (3) trained segmentation model; (4) trained object proposal and detection models; and (5) trained optical character recognition model. Generating pre-filtered annotations may include consensus mechanisms for using contributions of more than one of the annotation specialist models to generate a given pre-filtered annotation for an image.

At 330, method 300 includes, via operation of a data filtering and enhancement module, filtering the pre-filtered annotations in accordance with predefined noise criteria so as to output candidate annotations for the plurality of images. The filtering of the pre-filtered annotations may comprise filtering protocols on text data and region data. The filtering protocol on the text data may include filtering out texts containing excess objects. The filtering protocol on the text data may include retaining texts with a minimum action and object complexity. The filtering protocol on the region data may include removing noisy boxes under a confidence score threshold. The filtering protocol on the region data may include reducing redundant or overlapping bounding boxes.

At 340, method 300 includes, for each of one or more candidate annotations, selectively (1) storing the candidate annotation into the corpus as a final annotation for its associated image, or (2) adding the candidate annotation to its associated image using the one or more annotation specialist models and the data filtering and enhancement module for subsequent iterative annotation and filtering. The final annotations for each associated image may include at least a brief caption, a detailed caption, and a more detailed caption. The final annotations for each associated image may be associated with one or more of a detected object and a region of the associated image. The final annotations for each associated image may include at least a (1) text annotation, (2) region-text pair annotation, and (3) text-phrase-region triplet annotation.

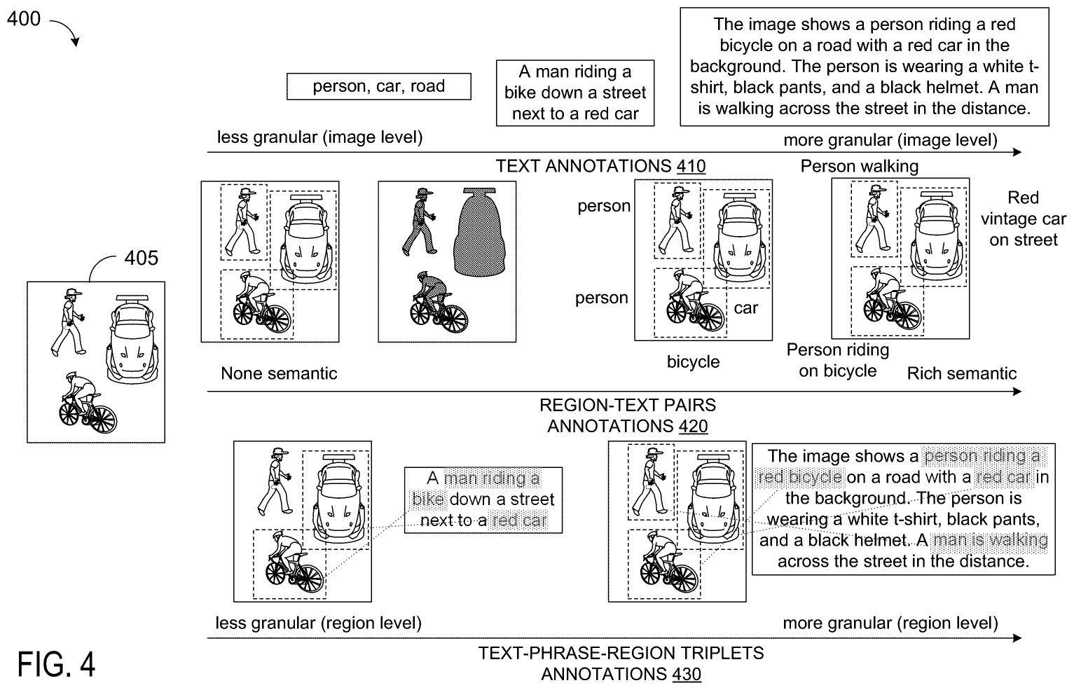

An illustrative example 400 of an image 405 and its corresponding annotations can be found in FIG. 4. Three discrete annotation categories are shown: text annotations 410, region-text pairs annotations 420, and text-phrase region triplet annotations 430. As an example, each image in FLD-5B is annotated with text, region-text pairs, and text-phrase-region triplets by the disclosed ALS-CV-MLM data engine, which covers multiple spatial hierarchies, brief-to-detailed progressive granularity, and a wide semantics spectrum, enabling more comprehensive visual understanding from diverse perspectives.

As an example, text annotations 410 may cover less granular to more granular image level captions. Region-text pairs annotations may cover none-semantic (no words, only a bounding box or identified object) to rich semantic annotations, each associated with a bounding box, mask, and/or identified object. Text-phrase-region triplets may cover less granular to more granular descriptions at the region level, with individual phrases of an annotation associated with a region of an image. Bounding boxes and masks may be described in text as a series of coordinates.

With data that supports comprehensive labels and different annotation representations, the same loss function and same framework can be used to implement multi-task computer vision problems. The unified data format thus supports unified tasks formulation.

As an example, the statistics and analysis of FLD-5B that were built using the data engine of FIG. 2 will be described. An overview of the dataset is presented and compared with the recent works. Further analyses of detailed annotation statistics, semantic coverage, spatial coverage, and data quality are shown in the established dataset.

Following the data engine, a large-scale training set (FLD-5B) of 126M images, more than 500M text annotations, 1.3B region-text annotations, and 3.6B text-phrase-region triplet annotations was built. Each image is annotated with text, region-text pairs, and text-phrase-region triplets and each annotation type has multiple instances varying in diverse granularity.

A comparative overview between this data set and the existing data sets commonly used in multi-task computer vision machine learning model training is presented in Table 1. Compared to existing work, the disclosed training data set has more annotations in total and, especially, more annotations per image. Furthermore, the richer annotations of one image cover multiple spatial hierarchies, brief-to-detailed progressive granularity, and a wide semantics spectrum, enabling more comprehensive visual understanding from diverse perspectives.

TABLE 1

| | Rep. | | | Spatial | Progressive | Semantics |
|---|---|---|---|---|---|---|
| Dataset | Model | #Images | #Annotations | Hierarchy | Granularity | Spectrum |
| JFT300M | ViT | 300M | 300M | Image- | Brief | Coarse |
| | | | | level | | |
| WIT | CLIP | 400M | 400M | Image- | Brief | Coarse |
| | | | | level | | |
| SA-1B | SAM | 11M | 1B | Region- | N/A | Non- |
| | | | | level | | semantic |
| GrIT | Kosmos-2 | 91M | 137M | Image & | Brief | Fine- |
| | | | | Region- | | grained |
| | | | | level | | |
| M3w | Flamingo | 185M | 43.3M | Multi- | Detailed | Fine- |
| | | | | image- | | grained |
| | | | | level | | |
| FLD-5b | ALS-CV-MLM | 126M | 5B | Image & | Brief to | Coarse |
| (present) | | | | Region | detailed | to fine- |
| | | | | level | | grained |

Table 1 shows a comparison with datasets in multi-task computer vision machine learning model training. Flamingo's annotations are counted in the number of documents, where each document may have multiple images.

The statistics for each annotation type within the FLD-5B dataset are presented in Table 2. Firstly, there are around 500M text annotations, including brief, detailed, and more detailed texts with different lengths. It is noteworthy that the detailed and more detailed text has 4× and 10× number of words compared with the brief text that is similar to COCO captions. These lengthy annotations provide much richer information for comprehensive visual understanding.

TABLE 2

| | | | | | | #Avg |
|---|---|---|---|---|---|---|
| Annotation | | #Image | #Avg | | #Avg | Regional |
| type | Text Type | Annotations | Tokens | #Regions | Regions | Tokens |
| Text | Brief | 235M | 7.95 | — | — | — |
| | Detailed | 126M | 31.65 | — | — | — |
| | More Detailed | 126M | 70.53 | — | — | — |
| Region- | Phrase | 126M | — | 681M | 5.42 | 1.19 |
| Text | Brief | 126M | — | 681M | 5.42 | 2.55 |
| Text- | Brief | 235M | 7.95 | 1007M | 4.27 | 1.93 |
| Phrase- | Detailed | 126M | 31.65 | 1289M | 10.25 | 1.49 |
| Region | More Detailed | 126M | 70.53 | 1278M | 10.17 | 1.35 |

In addition, this dataset has around 1.3B region-text annotations, which is more than 30× larger than the academic object detection datasets such as OpenImages and Object 365. On average, each image has around 5 regions, and each region is annotated with either a phrase or a relatively longer brief text. Note that the regional brief text (2.56 avg tokens) is shorter than typical brief text annotation (7.98 avg tokens), as the regional brief text annotation actually includes a mixture of phrase, noun chunks, and brief text based on the Florence-1.

Moreover, text-phrase-region triplet annotations were collected including more than 3.6B phrase-region pairs for the 500M text annotations. Specifically, the brief text annotation has 4.31 average phrase-region pairs while detailed and more detailed text annotation has more than 10 pairs, indicating that the richer text annotation covers more objects and their corresponding phrases in the text. Surprisingly, the phrases from the brief text tend to have more tokens on average than the ones from detailed and more detailed text. This may be due to the training data for the specialist model used for this annotation type.

The text annotations comprise multiple text types covering different magnitude of details. The semantic coverage of the text annotation was further analyzed to understand the distribution of semantic elements. Part-of-speech (POS) tags were obtained of each token and the dependency parsing tree among the tokens. Several heuristic rules were defined with POS tags and group tokens in semantic element types including objects, attributes, actions, and proper nouns. Furthermore, complexity of a token was defined by the total degrees of the token in the dependency parsing tree if treating the tree as an undirected graph. The complexity reflects the richness of the semantic connections of a certain token, and thus the complexity of objects and actions were measured. Table 3 shows the statistics of the average number of semantic elements and corresponding complexity in the FLD-5B dataset.

TABLE 3

| Text Type | Brief | Detailed | More detailed |
|---|---|---|---|
| #Image | 235M | 126M | 126M |
| Annotations | | | |
| #Avg Tokens | 7.95 | 31.65 | 70.53 |
| #Avg Objects | 3.23 | 13.31 | 28.06 |
| #Avg Attributes | 2.8 | 7.27 | 16.25 |
| #Avg Actions | 0.58 | 4.21 | 8.76 |
| #Proper Nouns | 1.1 | 2.4 | 2.41 |
| Avg Object | 2.8 | 4.00 | 4.02 |
| Complexity | | | |
| Avg Action | 1.14 | 3.63 | 4.38 |
| Complexity | | | |

Generally, all the measurements increase when the text annotation contains more details. Particularly, average actions have the most significant boost as the detailed and more detailed text gains 7× and 15× respectively compared with brief text. This reflects that the traditional brief text (or short caption) annotation has severe limitations in describing the action in the image. In contrast, the increment on proper nouns is relatively low. A potential reason is that the specialist tends to describe the objects in general terms rather than specific proper nouns. In terms of complexity measurement, both objects and actions have more semantic connections in the text with more details. This improves the complexity of the action, echoing the observation of the number of actions.

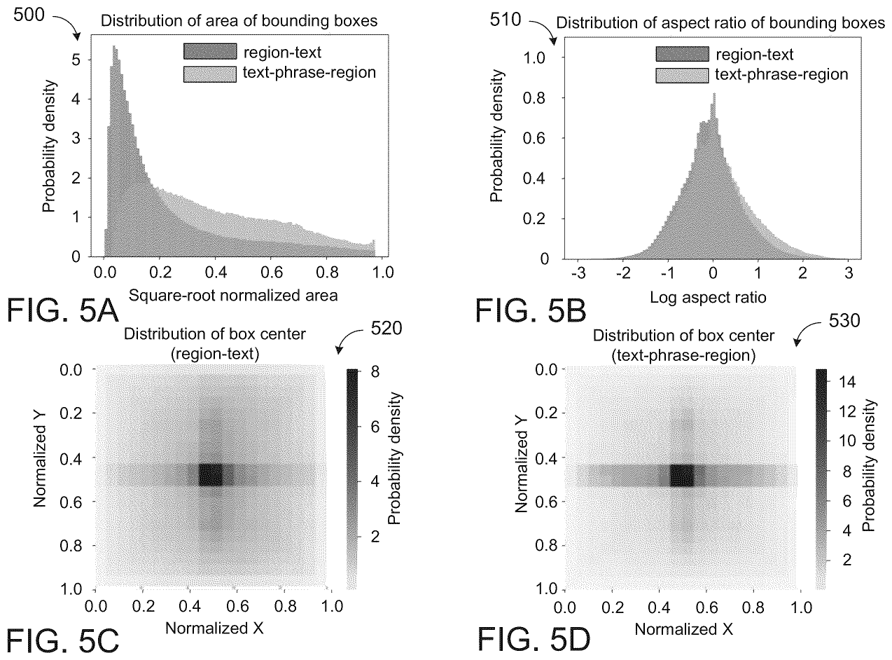

The region-text pair and text-phrase-region triplet annotations include regions represented by bounding boxes and masks to capture the location of visual concepts within the image. In this section, the spatial coverage of the regions is analyzed by identifying the properties of boxes. FIGS. 5A-5D present the distributions of bounding boxes in the FLD-5B dataset. In FIG. 5A, the distribution of box areas is presented in plot 500. The data reveals that the region-text pairs include more small boxes while text-phrase-region triplets have a more uniform distribution of box sizes. This disparity can be attributed to the divergent origins of these boxes. Those in the region-text pairs emerge from object detectors attuned to detecting localized objects, while those in the text-phrase-region triplets derive from a grounding model, which aligns boxes to textual phrases that can signify both localized and overarching image concepts. FIG. 5B illustrates the distribution of the aspect ratio in log format in plot 510. Region-text pairs and text-phrase-region triplets have similar distributions, and both are symmetric and cover a wide range of aspect ratios. FIGS. 5C and 5D demonstrate the heatmap of the box center for region-text (530) and text-phrase-region (540) annotation types respectively. The heatmaps indicate that both annotation types have a center bias, and the region-text pairs have a more uniform distribution compared with text-phrase-region triplets.

To develop a comprehensive multi-task computer vision machine learning model, a diverse set of multitask learning objectives were designed that cater to various aspects of visual understanding. The selection of these objectives is rigorously aligned with the predefined criteria: spatial hierarchy, progressive granularity, and semantic spectrum, inspired by recent research on multitask learning. This multitask learning approach incorporates three distinct learning objectives, each addressing a different level of granularity and semantic understanding:
Image-level understanding: Image-level tasks aim to capture high-level semantics and foster a comprehensive understanding of images through linguistic descriptions. These tasks enable the model to comprehend the overall context of an image and grasp semantic relationships and contextual nuances in the language domain. Example tasks include image classification, captioning, and visual question answering.

Region/pixel-level recognition: Region/pixel-level recognition tasks serve as an advanced form of learning objective that facilitates detailed object and entity localization within images. By focusing on specific objects and their locations, their tasks capture relationships between objects and their spatial context. Representative tasks encompass object detection, segmentation, and referring expression comprehension.

Fine-grained visual-semantic alignment: This task demands a fine-grained understanding of both text and image. It involves locating the regions in the image that correspond to the phrases in the text, such as objects, attributes, or relations. This task challenges the ability to capture the local details of visual entities and their semantic contexts, as well as the interactions between textual and visual elements. Phrase grounding can help explore the connections between visual elements, their descriptions, and the relationships between them.

In some examples, the disclosed ALS-CV-MLM learns to handle different levels of detail (from short to long) and semantic understanding (from shallow to deep) by combining these three learning objectives in a multitask learning framework. This strategic alignment enables the ALS-CV-MLM to deal with various spatial details, distinguish levels of detail in understanding, and go beyond surface-level recognition in its comprehension-ultimately learning a universal representation for vision understanding.

Second, the incorporation of spatial hierarchy, progressive granularity, and the semantic spectrum into a unified pre-training and singular network architecture has been lacking. In the field of computer vision, models have typically excelled in specific tasks, such as Mask-RCNN/DINO for object detection, Mask2Former/UPerNet for semantic segmentation, and BLIP/GIT primarily for image captioning, etc. Alternatively, foundational models may value additional fine-tuning of their adapters for transfer to other tasks. The absence of a comprehensive model design capable of accommodating these diverse dimensions limits the potential of multi-task computer vision machine learning models to serve as versatile foundations for downstream adaptation.

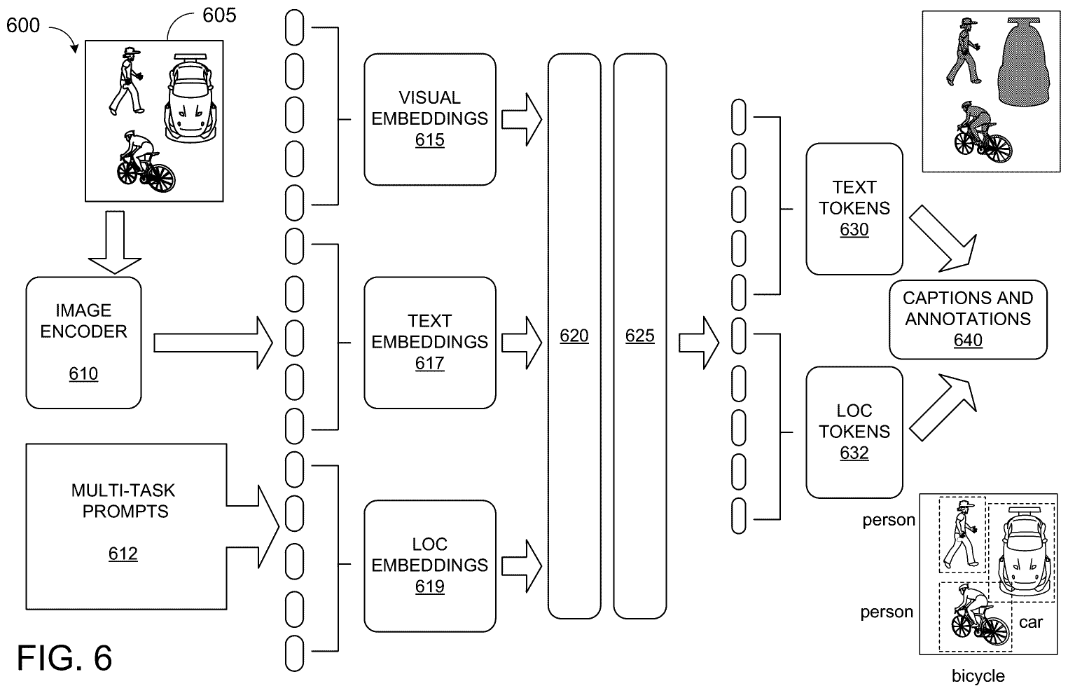

Herein is introduced an ALS-CV-MLM, specifically designed for comprehensive multitask learning that can handle various vision tasks with one model and one set of weights. As shown in FIG. 2, the disclosed ALS-CV-MLM enjoys a simple yet effective architecture by leveraging a sequence-to-sequence learning paradigm that integrates a plurality of tasks under a common language modeling objective. FIG. 6 schematically shows the disclosed ALS-CV-MLM (system 600) as comprising an image encoder and a multi-modality encoder-decoder. The disclosed ALS-CV-MLM was trained on the FLD-5B data in a unified multitask learning paradigm, resulting in a generalist multi-task computer vision machine learning model, which can perform a variety of vision tasks.

This is different from previous multitask learning methods, which use separate task-specific heads. The model accepts an image and a task prompt as inputs and produces a response that is relevant to the task. It comprises a vision encoder that transforms images into visual token embeddings, which are then concatenated with text embeddings and fed into a transformer-based multi-modal encoder-decoder to generate the response.

System 600 may be employed to annotate images, such as image 605. Image 605 is processed by image encoder 610. Prompts are received via multi-task prompts 612. Image encoder 605 encodes image 605 into a plurality of embedding tokens, including visual embeddings 615, text embeddings 617, and location (loc) embeddings 619. Embedding tokens and task prompts are provided to transformer encoders 620 and transformer decoders 625, which process the tokens as a seq-to-seq problem using a single set of weights and a single loss function. The transformers output text tokens 630 and loc tokens 632, which may then be used to generate captions and annotations 640.

A sequence-to-sequence framework is adopted to address various vision tasks in a unified manner. As shown in Table 4, each task is formulated as a translation problem: Given an input image and a task-specific prompt, the corresponding output response is generated.

TABLE 4

| Task | Annotation Type | Prompt Input | Output |
|---|---|---|---|
| Caption | Text | Image, text | Text |
| Detailed Caption | Text | Image, text | Text |
| More detailed | Text | Image, text | Text |
| caption | | | |
| Region proposal | Region | Image, text | Region |
| Object detection | Region-Text | Image, text | Text, region |
| Dense region | Region-Text | Image, text | Text, region |
| caption | | | |
| Phrase grounding | Text-Phrase- | Image, text | Text, region |
| | Region | | |
| Referring | Region-Text | Image, text | Text, region |
| expression | | | |
| comprehension | | | |
| Open vocabulary | Region-Text | Image, text | Text, region |
| detection | | | |
| Referring | Region-Text | Image, text | Text, region |
| segmentation | | | |
| Region to text | Region-Text | Image, text, | Text |
| | | region | |
| Text detection and | Region-Text | Image, text | Text, region |
| recognition | | | |

Depending on the task, the prompt and response can be either text or region:

Text: When the prompt or answer comprises plain text without any special formatting, it is kept as it is when it is transformed to the final sequence-to-sequence format.

Region: For region-specific tasks, location tokens are added to the tokenizer's vocabulary list, representing quantized coordinates. 1,000 bins are created, and represent regions using formats tailored to task requirements:

Box representation (x₁, y₁, x₂, y₂): Utilized in tasks such as object detection and dense region captioning, with location tokens corresponding to the box coordinates. The location tokens are the coordinates of the top-left and bottom-right corners of the box.

Quad box representation (x₁, y₁, . . . , x₄, y₄): For text detection and recognition tasks, using location tokens for each coordinate of the quadrilateral enclosing the text. The location tokens are the coordinates of each corner of the quad box, starting from the top-left and going clockwise.

Polygon Representation (x₁, y₁, . . . , xₙ, yₙ): For referring segmentation tasks, with location tokens representing the vertices of the polygon. The location tokens are the coordinates of the vertices of the polygon, in clockwise order.

By extending the tokenizer's vocabulary to include location tokens, the model is enabled to process region-specific information in a unified sequence-to-sequence learning format. This eliminates the need to design specific task heads for different tasks and allows for a more data-centric approach.

In some examples DaViT is adapted as the image encoder. Given the input image I∈ [symbol] ^{H×W×3}, where H and W represent the height and width, the image encoder converts it into flattened visual token embeddings V∈ [symbol] ^{N}^{ᵥ}^{×D}^{ᵥ}, with Nᵥ representing the number of vision tokens, and Dᵥ representing the dimensionality of each vision token embedding. Other image encoders are used in other examples.

A standard encoder-decoder transformer architecture can be used to process visual and language token embeddings. Prompt text embeddings Tₚᵣₒₘₚₜ∈ [symbol] ^{N}^{ₜ}^{×D} are first obtained using the extended language tokenizer and word embedding layer. Then, vision token embeddings are concatenated with prompt embeddings to form the multi-modality encoder module input, X=[V′,Tₚᵣₒₘₚₜ], where V′∈ [symbol] ^{N}^{ᵥ}^{×D} is obtained by applying a linear projection and LayerNorm layer to V for dimensionality alignment.

As an optimization objective, given the input x combined from the image and prompt, and target y, the standard language modeling can be used with cross-entropy loss for all the tasks. This is shown in Equation 1, where θ are the network parameters, and |y| is the number of target tokens.

$$ℒ = - {\sum }_{i = 1}^{\vert y \vert} log {P}_{θ} ( {y}_{i} \vert {y}_{< i} , x ) \qquad Eq . l$$

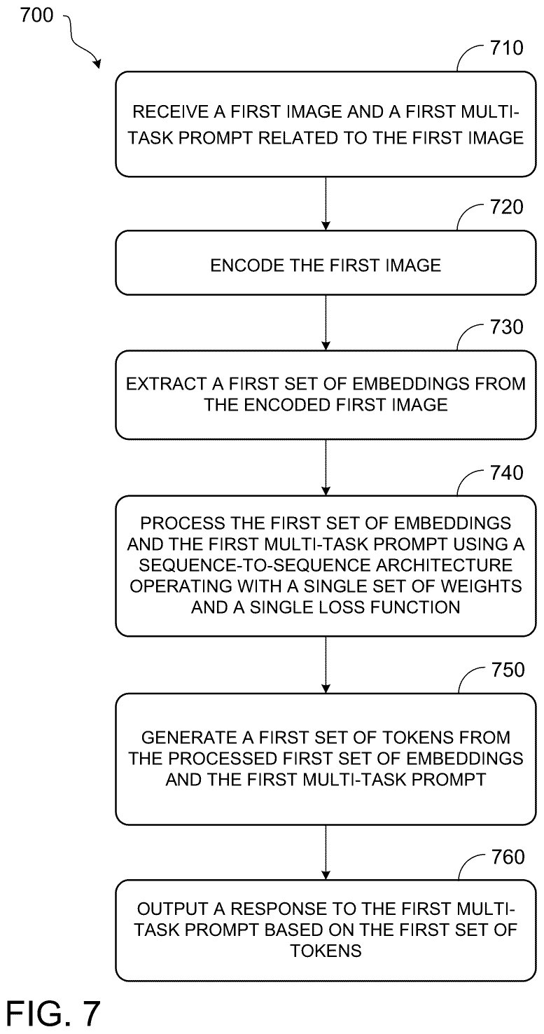

FIG. 7 shows a flow-diagram for an example method 700 for computer vision task formulation. Method 700 may be implemented by a computing system, such as system 600.

At 710, method 700 includes receiving a first image and a first multi-task prompt related to the first image. The first multi-task prompt may be an object detection prompt, a captioning prompt, or other image processing prompt. At 720, method 700 includes encoding the first image. At 730, method 700 includes extracting a first set of embeddings from the encoded first image. The first set of embeddings may include one or more of visual embeddings, text embeddings, and location embeddings. At 740, method 700 includes processing the first set of embeddings and the first multi-task prompt using a sequence-to-sequence architecture operating with a single set of weights and a single loss function. The sequence-to-sequence architecture may comprise a transformer encoder and a transformer decoder.

At 750, method 700 includes generating a first set of tokens from the processed first set of embeddings and the first multi-task prompt. The first set of tokens may include one or more of text tokens and location tokens. At 760, method 700 includes outputting a response to the first multi-task prompt based on the first set of tokens.

In some examples, method 700 may include receiving a second image and a second multi-task prompt related to the second image, encoding the second image, and extracting a second set of embeddings from the encoded second image. The method may further include processing the second set of embeddings and the second multi-task prompt using the sequence-to-sequence architecture operating with the single set of weights and the single loss function. Method 700 may further include generating a second set of tokens from the processed second set of embeddings and the second multi-task prompt and outputting a response to the second multi-task prompt based on the second set of tokens. In this way, the single set of weights and the single loss function can be applied to a plurality of images and multi-task prompts.

In some examples, method 700 may include receiving a third multi-task prompt related to the first image and processing the first set of embeddings and the third multi-task prompt using the sequence-to-sequence architecture operating with the single set of weights and the single loss function. Method 700 may further include generating a third set of tokens from the processed first set of embeddings and the third multi-task prompt and outputting a response to the third multi-task prompt based on the third set of tokens. In this way, the single set of weights and the single loss function can be applied to a plurality of multi-task prompts related to a single image.

The presently disclosed ALS-CV-MLM can be trained on FLD-5B to learn a universal image representation. Experiments were conducted in three main parts: (1) The zero-shot performance of the method was evaluated on various tasks to show its inherent ability to handle multiple tasks without any extra fine-tuning on task-specific data using one single generalist's model. (2) The adaptability of the method was shown by further training one single generalist's model with additional supervised data on a wide range of tasks, achieving competitive state-of-the-art performance. (3) The performance of the learned visual representation was evaluated on the downstream tasks as the backbone to show the superiority of the presently disclosed pre-training method over previous approaches.

Two model variants with different sizes were evaluated: ALS-CV-MLM--B model with 232 million parameters and ALS-CV-MLM-L model with 771 million parameters. The detailed architectures of each model are given in Table 5. The weights of the image encoder and multi-modality encoder-decoder were initialized from UniCL and BART, respectively.

TABLE 5

| | Image Encoder | | | |
|---|---|---|---|---|
| | (DaViT) | | | |
| Model | dimensions | blocks | Heads/groups | #params |
| ALS-CV- | [128, 256, 512, | [1, 1, 9, 1] | [4, 8, 16, 32] | 0.09B |
| MLM -B | 1024] | | | |
| ALS-CV- | [256, 512, 1024, | [1, 1, 9, 1] | [8, 16, 32, 64] | |
| MLM -L | 20481 | | | |
| | Encoder | | | |
| | (Transformer) | | | |
| | layers | dimensions | #params | |
| ALS-CV- | 6 | 768 | | |
| MLM -B | | | | |
| ALS-CV- | 12 | 1024 | | |
| MLM -L | | | | |
| | Decoder | | | |
| | (Transformer) | | | |
| | layers | dimensions | #params | |
| ALS-CV- | 6 | 768 | | |
| MLM -B | | | | |
| ALS-CV- | 12 | 1024 | | |
| MLM -L | | | | |

AdamW with cosine learning rate decay was adopted for training the presently disclosed models. Deepspeed and mixed precision were leveraged to improve the training efficiency. The maximum learning rate was set at 1e−4 for the base model and 1e−5 for the large model. A linear warmup to the maximum learning rate was applied during the first 5,000 optimization steps.

The presently disclosed models were trained with a mini-batch size of 2048/3072 (base/large) and an image size of 384×384 until reaching 3 billion effective training samples. Similar to previous work, high resolution tuning was further conducted with an image size of 768×768 for 0.5 billion samples for the base model and 0.1 billion samples for the large model.

A powerful multi-task computer vision machine learning model is presented herein that does not require task-specific supervised annotations for finetuning. The zero-shot performance of such a model is shown in Table 6. Table 6 shows the zero-shot performance of generalist vision foundation models. The models do not see the training data of the evaluation tasks during training. ALS-CV-MLM models are pre-trained on FLD-5B dataset.

TABLE 6

| | | COCO Cap. | NoCaps | TextCaps | COCO Det | Flickr30k |
|---|---|---|---|---|---|---|
| Method | #params | CIDEr | CIDEr | CIDEr | AP | R@1 |
| Flamingo | 80B | 84.3 | — | — | — | — |
| Kosmos-2 | 1.6B | — | — | — | — | 77.8 |
| ALS-CV- | 0.23B | 133.0 | 118.7 | 70.1 | 34.7 | 82.0 |
| MLM -B | | | | | | |
| ALS-CV- | 0.77B | 135.6 | 120.8 | 72.8 | 37.5 | 83.0 |
| MLM -L | | | | | | |

| | Ref- | | | Ref- | | | Ref- | | Ref- | |
|---|---|---|---|---|---|---|---|---|---|---|
| | coco | | | coco+ | | | cocog | | coco RES | |
| Method | val | Test-A | Test-B | val | Test-A | Test-B | val | test | mIOU | oIOU |
| Flamingo | — | — | — | — | — | — | — | — | — | — |
| Kosmos-2 | 52.3 | 57.4 | 47.3 | 45.5 | 50.7 | 42.2 | 60.6 | 61.7 | — | — |
| ALS-CV- | 53.9 | 58.4 | 49.7 | 51.5 | 56.4 | 47.9 | 66.3 | 65.1 | 34.6 | 28.4 |
| MLM -B | | | | | | | | | | |
| ALS-CV- | 56.3 | 61.6 | 51.4 | 53.6 | 57.9 | 49.9 | 68.0 | 67.0 | 35.8 | 28.8 |
| MLM -L | | | | | | | | | | |

For image-level tasks, ALS-CV-MLM-L achieved a 134.9 CIDEr score on the COCO caption benchmark, utilizing less than 1% of the parameters compared to the 80B Flamingo model (which has an 84.3 CIDEr score). For region-level grounding and referring expression comprehension tasks, ALS-CV-MLM-L established a new record in zero-shot performance achieving a 5.2 improvement in Flickr30k Recall@1, and approximately 4%, 8%, and 8% absolute improvements on Refcoco, Refcoco+, and Refcocog, respectively, compared to the Kosmos-2 model, which has 1.6B parameters. Additionally, this pretrained model attained a 35.78% mIOU in the Refcoco referring expression segmentation (RES) task during zeroshot fine-tuning, a capability not supported by prior foundation models.

Herein, the versatility and effectiveness of the disclosed ALS-CV-MLM as a vision foundation that can be transferred to various downstream tasks is demonstrated. ALS-CV-MLM models were fine-tuned with a collection of supervised datasets that cover image-level, region-level, pixel-level tasks, yielding one generalist model for various vision tasks. Tables 7 and 8 compare this model with other state-of-the-art models. Table 7 shows the performance of specialist and generalist models on captioning and VQA tasks. Asterisks indicate usage of external OCR as input. Table 6 shows the performance of specialist and generalist models on region-level tasks.

TABLE 7

| | | COCO | | | | | |
|---|---|---|---|---|---|---|---|
| | | Caption | NoCaps | TextCaps | VQAv2 | TextVQA | Viz Wiz |
| Method | #params | CIDEr | CIDEr | CIDEr | Acc | Acc | VQA Acc |
| Specialist | | | | | | | |
| Models | | | | | | | |
| CoCa | 2.1B | 143.6 | 122.4 | — | 82.3 | — | — |
| BLIP-2 | 7.8B | 145.2 | 121.0 | — | 82.2 | — | — |
| GIT2 | 5.1B | 145 | 126.9 | 148.6 | 81.7 | 67.3 | 71.0 |
| Flamingo | 80B | 138.1 | — | — | 82.0 | 54.1 | 65.7 |
| PaLI | 17B | 149.1 | 127.0 | 160.0 * | 84.3 | 58.8/73.1* | 71.6/74.4* |
| PaLI-X | 55B | 149.2 | 126.3 | 147/163.7* | 86.0 | 71.4/80.8* | 70.9/74.6* |
| Generalist | | | | | | | |
| Models | | | | | | | |
| Unified-IO | 2.9B | — | 100 | — | 77.9 | — | 57.4 |
| ALS-CV- | 0.23B | 140.0 | 116.7 | 143.9 | 79.7 | 63.6 | 63.6 |
| MLM -B | | | | | | | |
| ALS-CV- | 0.77B | 143.3 | 124.9 | 151.1 | 81.7 | 73.5 | 72.6 |
| MLM -L | | | | | | | |

TABLE 8

| | | COCO | | | | | | | | | | Refcoco | |
|---|---|---|---|---|---|---|---|---|---|---|---|---|---|
| | | Det | Flickr30k | Refcoco | | | Refcoco+ | | | Refcocog | | RES | |
| Method | #params | AP | R@1 | val | Test-A | Test-B | val | Test-A | Test-B | val | test | mIOU | oIOU |
| Specialist | | | | | | | | | | | | | |
| Models | | | | | | | | | | | | | |
| SeqTR | — | — | — | 83.7 | 86.5 | 81.2 | 71.5 | 76.3 | 64.9 | 74.9 | 74.2 | — | — |
| PolyFormer | — | — | — | 90.4 | 92.9 | 87.2 | 85.0 | 89.8 | 78.0 | 85.8 | 85.9 | 76.9 | 76.0 |
| UNINEXT | 0.74B | 60.6 | — | 92.6 | 94.3 | 91.5 | 85.2 | 89.6 | 79.8 | 88.7 | 89.4 | — | 82.2 |
| Ferret | 13B | — | — | 89.5 | 92.4 | 84.4 | 82.8 | 88.1 | 75.2 | 85.8 | 86.3 | — | — |
| CogVLM | 17B | — | — | 92.5 | 94.0 | 88.7 | 87.5 | 91.8 | 81.4 | 89.5 | 90.1 | — | — |
| Generalist | | | | | | | | | | | | | |
| Models | | | | | | | | | | | | | |
| UniTAB | | — | — | 88.6 | 91.1 | 83.8 | 81.0 | 85.4 | 71.6 | 84.6 | 84.7 | — | — |
| ALS-CV- | 0.23B | 41.4 | 83.7 | 92.6 | 94.8 | 91.5 | 86.8 | 91.7 | 82.2 | 89.8 | 82.2 | 78.0 | 74.8 |
| MLM B | | | | | | | | | | | | | |
| ALS-CV- | 0.77B | 43.4 | 84.7 | 93.4 | 95.3 | 92.0 | 88.3 | 92.9 | 83.6 | 91.2 | 91.7 | 80.5 | 77.5 |
| MLM L | | | | | | | | | | | | | |

Several novel findings are presented herein. 1) Simple design for strong performance: the disclosed ALS-CV-MLM demonstrates strong performance with standard multimodality Transformer encoder-decoder without special designs, particularly for region-level and pixel-level tasks. For example, ALS-CV-MLM-L outperformed PolyFormer on both RefCOCO REC task and RES task by 3.0 Accuracy@ 0.5 and 3.54 mIOU respectively, where Poly-Former adapts specifically designed regression-based prediction head for coordinates. ALS-CV-MLM-L also outperformed the previous SOTA method UNINEXT on RefCOCO by 0.76 Accuracy@0.5, where UNINEXT is based on advanced object detector Deformable DETR and DINO.

2) Competitive performance with fewer parameters: ALS-CV-MLM-L achieved competitive performance without the need for large LLMs, showcasing efficiency in handling diverse tasks while maintaining a compact size. For instance, ALS-CV-MLM-L attained a CIDEr score of 140.0 on the COCO Caption karpathy test split, outperforming models with significantly more parameters, such as Flamingo (80B parameters, 138.1 CIDEr score).

3) Adaptable generalization across task levels: the disclosed ALS-CV-MLM demonstrated competitive performance across image-level, pixel-level, and region-level tasks, emphasizing its adaptability and effectiveness in addressing various challenges in computer vision and natural language processing. For example, in the TextVQA task, ALS-CV-MLM-L set a new state-of-the-art performance with an accuracy of 81.5 without any external OCR token input, surpassing previous SOTA methods.

These achievements emphasize the disclosed ALS-CV-MLM's efficiency in handling diverse tasks while maintaining a compact size, making it a valuable asset in the ever-evolving landscape of AI research and applications.

The performance of the single model fine-tuning was investigated on downstream tasks. This experiment highlights the superiority of the disclosed ALS-CV-MLM pre-training over previous approaches, as it demonstrates the effectiveness of the learned universal image representation. The base size model with about 80M parameters was used in these experiments to ensure fair comparison with other methods.

COCO object detection and instance segmentation experiments were conducted with Mask R-CNN, and COCO object detection experiments with DINO to further demonstrate the effectiveness of the disclosed ALS-CV-MLM pre-training. Models were trained on the train2017 split and evaluated on the val2017 split. Following the common setup used previously, the standard 1× (12 epochs) schedule with multi-scale training was used for all experiments. Thanks to the strong universal representation learned by the disclosed ALS-CV-MLM pre-training, longer training epochs, such as 36 epochs or 100 epochs are not required as in previous work, to achieve better results. The learning rate is stepped down by a factor of 0.1 at the 67% and 89% of training epochs. No additional augmentation was used (such as random crop, mosaic, etc.) nor optimization techniques (such as EMA, weight normalization) during training to ensure a fair comparison. Test time augmentation (TTA) was not used either.

First, the disclosed base model achieved a strong performance improvement compared to other approaches. As shown in Table 9, the DaViT-B model pre-trained by the disclosed ALS-CV-MLM surpasses previous best base model (ConvNext v2-B), which is pre-trained by FCMAE, by 0.7 APb using Mask RCNN. Table 9 shows COCO object detection and instance segmentation results using Mask-RCNN framework, and COCO object detection results using DINO-4scale framework. All the entries used a base size model to ensure a fair comparison. For Mask-RCNN experiments, the disclosed method utilized 1× schedule (12 epochs), ViT-B uses 100 epochs, all others use 3× (36 epochs). For DINO experiments, all the entries used 1× schedule except for ViT-B which used 50 epochs.

TABLE 9

| | | Mask R-CNN | | DINO |
|---|---|---|---|---|
| Backbone | Pretrain | AP_{b} | APₘ | AP |
| ViT-B | MAE, IN-1k | 51.6 | 45.9 | 55.0 |
| Swin-B | Sup 1N-1k | 50.2 | — | 53.4 |
| Swin-B | SimMIM | 52.3 | — | — |
| FocalAtt-B | Sup 1N-1k | 49.0 | 43.7 | — |
| FocalNet-B | Sup 1N-1k | 49.8 | 44.1 | 54.4 |
| ConNeXt v1-B | Sup 1N-1k | 50.3 | 44.9 | 52.6 |
| ConNeXt v2-B | Sup 1N-1k | 51.0 | 45.6 | — |
| ConNeXt v2-B | FCMAE | 52.9 | 46.6 | — |
| DaViT-B | ALS-CV- | 53.6 | 46.4 | 59.2 |
| | MLM | | | |

While ConvNext v2-B leverages a 3× schedule (36 epochs), the disclosed model efficiently employed a 1× schedule (12 epochs) thanks to powerful pre-trained universal representation. For DINO framework, the disclosed model significantly outperformed the ViT-B, achieving a notable improvement of 4.2 AP.

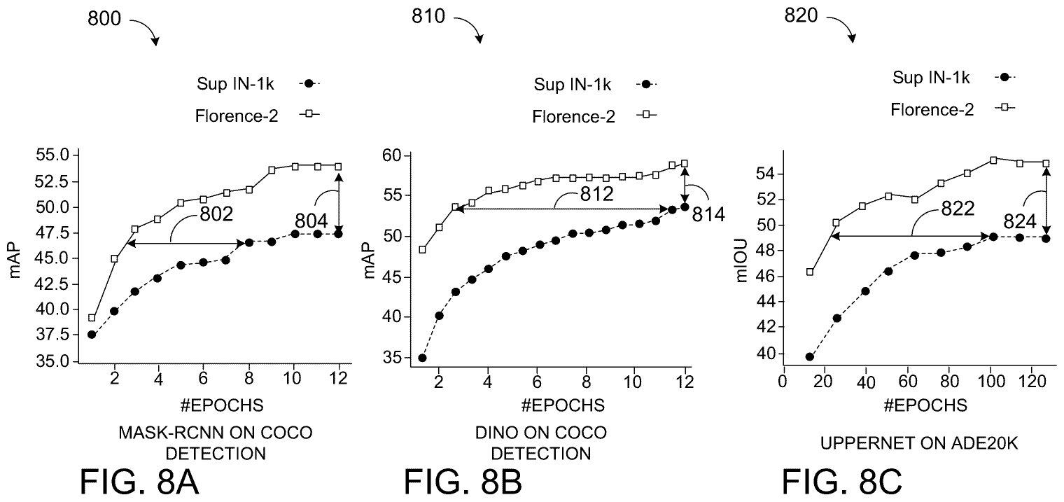

Second, this pre-training demonstrates higher training efficiency. As shown in Table 10 and FIG. 8A-8C, compared to the model with supervised ImageNet-1k pre-training, the model with ALS-CV-MLM pre-training achieved 4× efficiency and a significant improvement of 6.4 AP and 5.5 AP with Mask-RCNN and DINO framework, respectively. At 800, FIG. 8A shows training efficiency on COCO object detection. A 4× efficiency gain is indicated at 802. An improvement of 6.9 points is indicated at 804. At 810, FIG. 8B shows training efficiency on COCO segmentation. A 4× efficiency gain is indicated at 812. An improvement of 5.5 points is indicated at 814. At 820, FIG. 8C shows training efficiency on ADE20K semantic segmentation tasks. A 4× efficiency gain is indicated at 822. An improvement of 5.9 points is indicated at 824.

Third, this pre-training provides a good generic representation without extensive fine-tuning. Table 10 indicates that the models with ALS-CV-MLM pre-training maintain competitive performances when the first two stages are frozen with only 0.3 and 0.2 drops for Mask-RCNN and DINO, respectively. Table 10 shows downstream task fine-tuning on COCO and ADE20K dataset. COCO object detection used Mask R-CNN and DINO. ADE20K semantic segmentation used UperNet. All entries use DaViT-B with 80M parameters as the backbone and standard 1× schedule. Moreover, the disclosed ALS-CV-MLM approach with a completely frozen backbone can outperform the model with supervised ImageNet-1k pre-training by 1.6 and 2.4 for Mask-RCNN and DINO.

TABLE 10

| | | Mask R- | | | |
|---|---|---|---|---|---|
| | Frozen | CNN | | DINO | UperNet |
| Pretrain | Stages | AP_{b} | APₘ | AP | mIoU |
| Sup 1N1k | n/a | 46.7 | 42.0 | 53.7 | 49 |
| UniCL | n/a | 50.4 | 45.0 | 57.3 | 53.6 |
| ALS-CV- | n/a | 53.6 | 46.4 | 59.2 | 54.9 |
| MLM | | | | | |
| ALS-CV- | [1] | 53.6 | 46.3 | 59.2 | 54.1 |
| MLM | | | | | |
| ALS-CV- | [1, 2] | 53.3 | 46.1 | 59.0 | 54.4 |
| MLM | | | | | |
| ALS-CV- | [1, 2, 3] | 49.5 | 42.9 | 56.7 | 49.6 |
| MLM | | | | | |
| ALS-CV- | [1, 2, 3, 4] | 48.3 | 44.5 | 56.1 | 45.9 |
| MLM | | | | | |

Semantic segmentation experiments were conducted with UperNet framework on ADE20k dataset. The training and evaluation protocols from Swin were mostly reused. Specifically, an input size of 512×512 was used and the model trained for 40k iterations with a batch size of 64. The AdamW optimizer with the optimal learning rate searched from {8e−4,4e−4,2e−4,1e−4} was adopted.

The results of these experiments show a similar trend to the object detection experiments. As illustrated in Table 11, the base model outperformed the previous SoTA model, which is BEiT pretrained ViT-B, by 1.3 and 1.4 points in single-scale and multi-scale testing protocol, respectively. Table 11 shows ADE20K semantic segmentation results using UperNet. The input size was 512×521 for all the entries, except for models with BEiT pre-trained, which used the input size of 640×640.

TABLE 11

| Backbone | Pretrain | mIoU | ms-mIoIU |
|---|---|---|---|
| Vit-B | Sup IN-1k | 47.4 | — |
| Vit-B | MAE-IN-1k | 48.1 | — |
| Vit-B | BEiT | 53.6 | 54.1 |
| Vit-B | BEiTv2 1N-1k | 53.1 | — |
| Vit-B | BEiTv2 1N-22k | 53.5 | — |
| Swin-B | Sup IN-1k | 48.1 | 49.7 |
| Swin-B | Sup IN-22k | — | 51.8 |
| Swin-B | SimMIM | — | 52.8 |
| FocalAtt-B | Sup IN-1k | 49.0 | 50.5 |
| FocalAtt-B | Sup IN-1k | 50.5 | 51.4 |
| ConvNeXt v1-B | Sup IN-1k | — | 49.9 |
| ConvNeXt v2-B | Sup IN-1k | — | 50.5 |
| ConvNeXt v2-B | FCMAE | — | 52.1 |
| DaViT-B | ALS-CV-MLM | 54.9 | 55.5 |

With the same backbone architecture of DaViT-B, the disclosed ALS-CV-MLM pretrained model achieves a remarkable improvement of 4.9 points and 4× efficiency compared to the ImageNet-1k pretrained counterpart as demonstrated in Table 5 and FIGS. 8A-8C.

Ablation studies, such as multitask transfer were performed. In this study, the aim was to identify the most effective pre-trained model for transfer learning across various downstream tasks in computer vision. Three different models were compared, each pre-trained on a different combination of tasks:
Image-level model: pre-trained on image-level tasks only
Image-Region model: pre-trained on image-level and region-level tasks
Image-Region-Pixel model: pre-trained on image-level, region-level, and pixel-level tasks

For pre-training, all models were optimized for the same number of effective samples (72M) on a subset of the FLD-5B dataset.

These models were then transferred to a combined dataset with four downstream tasks, each representing a different level of task granularity: COCO caption (image-level task), COCO object detection (region-level task), Flickr30k grounding (region-level task), RefCOCO referring segmentation (pixel-level task).

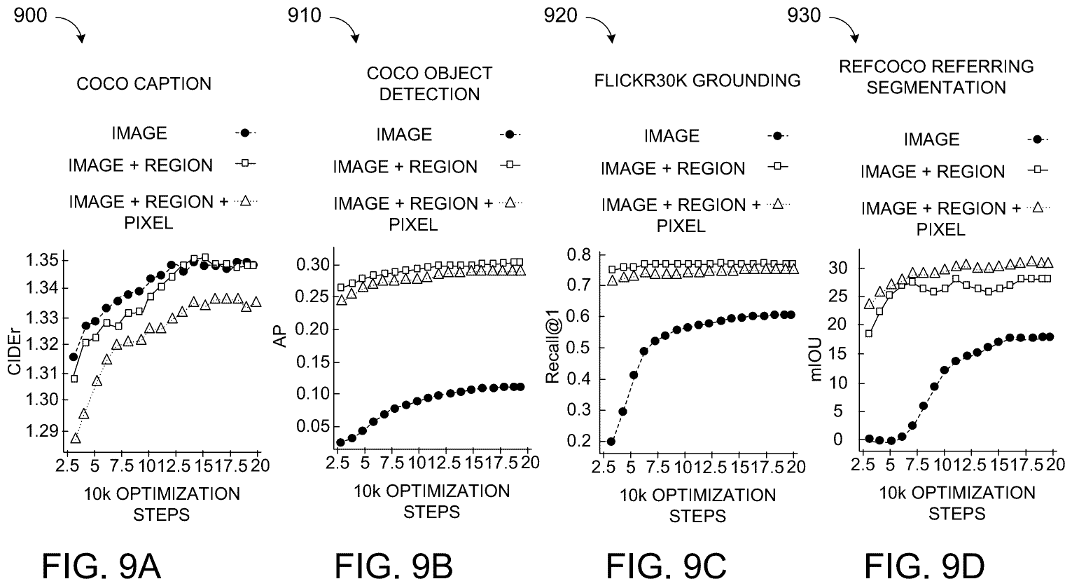

The results are shown in FIG. 9A-9D. The results demonstrate that Image-Region-Pixel Model, pre-trained on all three levels of tasks, consistently demonstrated competitive performance across the four downstream tasks. FIGS. 9A-9D show the results of multitask transfer experiments. Experiments were conducted with three different versions of ALS-CV-MLM, each trained on a different level of image annotation: image level, image and region level, and image, region, and pixel level. The transfer learning performance of these models were then evaluated on four downstream tasks: COCO caption, COCO object detection, Flickr30k grounding, and Refcoco referring segmentation.

FIG. 9A shows an example plot 910 indicating COCO captioning over 20,000 optimization steps. For the COCO caption task, the Image-Region-Pixel model initially performed worse than the Image-level model and the Image-Region model but eventually achieved a final performance (133.4 CIDEr) that is only slightly worse than the other models (134.6 CIDEr).

FIG. 9B shows an example plot 920 indicating COCO object detection over 20,000 optimization steps. For the COCO object detection task, the Image-Region-Pixel model outperformed the Image-level model by a significant margin (28.3 vs. 0.1) and was only slightly worse than Image-Region model (29.7).

FIG. 9C shows an example plot 930 indicating Flickr30k grounding over 20,000 optimization steps. For the Flickr30k grounding task, Image-Region-Pixel model showed strong performance (78.1 recall@1), comparable to the Image-Region model (79.1 recall@1) and significantly better than the Image-level model (62.0 recall@1).

FIG. 9D shows an example plot 940 indicating over RefCoco referring segmentation 20,000 optimization steps. For the RefCoco referring segmentation task, the Image-Region-Pixel model clearly outperformed both the Image-level model and the Image-Region model, achieving the highest performance (31.6 mIoU) compared to the other models (28.4 and 18.2 mIoU).

These findings suggest that the Image-Region-Pixel model, which is pre-trained on tasks at the image, region, and pixel levels, is the most effective base model for transfer learning across various computer vision tasks. This model showed strong performance on all four downstream tasks that were evaluated, and consistently outperformed the Image-level model and matched or exceeded the Image-Region model in performance. By pre-training a model on tasks at different levels of granularity, it can be ensured that the base model is more prepared to handle a diverse range of downstream tasks, offering a versatile and robust solution for transfer learning in computer vision.

The impact of increasing model capacity on zero-shot performance was investigated on various downstream tasks in computer vision. Two models were compared: ALS-CV-MLM-B and ALS-CV-MLM-L, which have 232M and 771M parameters, respectively. The model architectures are described in Table 5. The zero-shot performance on four downstream tasks are shown in Table 12. The large model clearly outperformed the base model across various downstream tasks. Table 12 shows model scaling. Zero-shot performance was evaluated on COCO caption and COCO object detection, Flickr30k grounding, and RefCOCO referring expression segmentation (RES).

TABLE 12

| | Caption | Detection | Grounding | RES | |
|---|---|---|---|---|---|
| Model | CIDEr | AP | Recall@1 | mIOU | oIOU |
| Base | 118.7 | 19.7 | 76.3 | 18.6 | 17.8 |
| Large | 124.4 | 22.6 | 78.2 | 21.5 | 19.1 |

Experiments were conducted to study how zero-shot performance on various computer vision tasks is affected by the scale of pre-training data. Four different data sizes were used for pre-training: 0.12M, 0.36M, 1.2M, and 12M images. All models were trained with the same effective sample size (72M) on a subset of FLD-5B data.

Table 13 presents the zero-shot performance results on COCO caption, COCO object detection, Flickr30k grounding, and RefCoco referring segmentation (RES) tasks. Table 13 shows data scaling including Zero-shot performance on COCO caption, COCO object detection, Flickr30k grounding, COCORef referring segmentation. A trend can be observed of improved zero-shot performance on the downstream tasks as the pre-training data size increases (except for RES, 1.2M data has slightly better performance compared to 12M).

TABLE 13

| | Caption | Detection | Grounding | RES | |
|---|---|---|---|---|---|
| Data Size | CIDEr | AP | Recall@1 | mIOU | oIOU |
| 0.12M | 102.8 | 16.1 | 74.0 | 15.9 | 16.6 |
| 0.36M | 114.3 | 18.7 | 75.8 | 16.6 | 16.4 |
| 1.2M | 118.1 | 18.9 | 76.3 | 19.3 | 18.4 |
| 12M | 118.7 | 19.7 | 76.3 | 18.6 | 17.8 |

These experiments on model scaling demonstrate that larger pre-training data sizes generally lead to improved zero-shot performance across a variety of downstream tasks in computer vision. This finding suggests that investing in larger pre-training datasets can provide a more effective and versatile foundation for handling a wide range of downstream tasks.

The disclosed approach to scaling data is significantly more efficient than relying solely on human annotations, as most of the annotation generation is performed using model inference. By leveraging specialist models to generate annotations, the time and cost associated with manual annotation efforts can be substantially reduced, which often involves labor-intensive processes and may be subject to human errors or inconsistencies.

Furthermore, utilizing model-generated annotations enables scaling of the pre-training datasets more rapidly and efficiently, allowing for exploration of the impact of larger data sizes on model performance across various downstream tasks in computer vision. This not only facilitates the development of more effective and versatile multi-task computer vision machine learning models but also ensures that the annotation process remains sustainable and scalable as the demand for high-quality labeled data continues to grow.

In summary, the disclosed data scaling approach offers a more efficient alternative to traditional human annotation methods by harnessing the power of specialist models for annotation generation. This strategy enables the acceleration of the pretraining process, optimizes model performance, and effectively manages the ever-increasing demand for labeled data in the field of computer vision.

The basic model training settings were analyzed for the two primary components of the disclosed model, namely the vision encoder and the multi-modality encoder-decoder. The experiment results are presented in Table 14. Table 14 shows basic components, including Zero-shot performance on COCO caption, COCO object detection, Flickr30k grounding, and COCORef referring segmentation. V Pre and L Pre indicate using vision and language pre-training initialization, respectively.

TABLE 14

| | | Caption | Detection | Grounding | RES | |
|---|---|---|---|---|---|---|
| V Pre | L Pre | CIDEr | AP | Recall@1 | mIOU | oIOU |
| Freeze | | | | | | |
| Vision | | | | | | |
| Encoder | | | | | | |
| * | * | 120.0 | 6.9 | 66.3 | 9.9 | 13.6 |
| Unfreeze | | | | | | |
| Vision | | | | | | |
| Encoder | | | | | | |
| | * | 81.3 | 4.9 | 69.0 | 15.3 | 15.6 |
| * | | 117.4 | 19.6 | 75.2 | 21.5 | 19.3 |
| * | * | 118.7 | 19.7 | 76.3 | 18.6 | 17.8 |

It can be observed that freezing the vision encoders does not affect the performance on tasks that require image-level understanding, but it significantly degrades the performance on tasks that require region-level or pixel-level understanding (e.g., AP on COCO object detection drops from 19.7 to 6.9). Previous methods for pre-training multi-task computer vision machine learning models mainly focus on image-level tasks (e.g., image classification, image-text contrastive learning), which may not provide them with sufficient region-level and pixel-level skills for downstream tasks. Therefore, it is valuable to unfreeze the vision backbone, enabling it to learn region-level and pixel-level features for various downstream tasks.

The effect of language pre-training weights on multimodal encoder-decoder tasks varies depending on the task. Tasks that require more text understanding, such as captioning and grounding, benefit slightly from using language pretraining weights (e.g., COCO caption, Flickr30k grounding). Tasks that are mostly vision-focused, such as object detection and region segmentation, do not gain much from using language pre-training weights (for COCO object detection, the gain is only 0.1; for RES tasks, which use only localization tokens, the drop is 2.91 mIOU).

The effects of different training configurations on the performance of a multi-task computer vision machine learning model were investigated in region-level and pixel-level tasks. The results indicate that unfreezing the vision backbone is valuable for enhancing the model's ability to learn from regions and pixels, which is beneficial for transferring to various downstream tasks. Moreover, it is observed that using language pre-training weights can help the model in tasks that require text understanding but have less impact on tasks that are purely vision-based. These results offer useful guidance for choosing training settings for different computer vision tasks.

In some embodiments, the methods and processes described herein may be tied to a computing system of one or more computing devices. In particular, such methods and processes may be implemented as a computer-application program or service, an application-programming interface (API), a library, and/or other computer-program product.

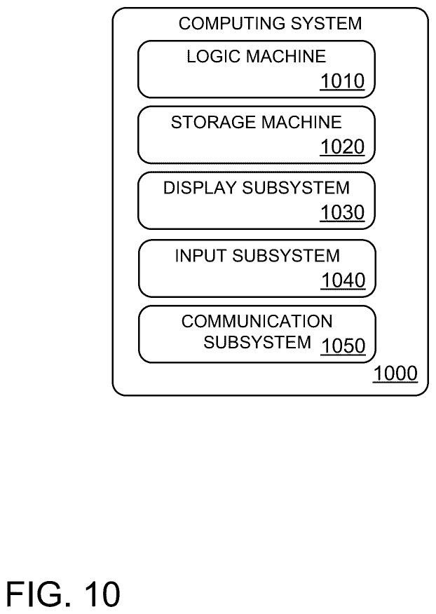

FIG. 10 schematically shows a non-limiting embodiment of a computing system 1000 that can enact one or more of the methods and processes described above. Computing system 1000 is shown in simplified form. Computing system 1000 may take the form of one or more personal computers, server computers, tablet computers, home-entertainment computers, network computing devices, gaming devices, mobile computing devices, mobile communication devices (e.g., smart phone), and/or other computing devices.

Computing system 1000 includes a logic machine 1010 and a storage machine 1020. Computing system 1000 may optionally include a display subsystem 1030, input subsystem 1040, communication subsystem 1050, and/or other components not shown in FIG. 10. Systems 200 and 600 may be examples of computing system 1000.

Logic machine 1010 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 1020 includes one or more physical devices configured to hold instructions executable by the logic machine to implement the methods and processes described herein. When such methods and processes are implemented, the state of storage machine 1020 may be transformed—e.g., to hold different data.

Storage machine 1020 may include removable and/or built-in devices. Storage machine 1020 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 1020 may include volatile, nonvolatile, dynamic, static, read/write, read-only, random-access, sequential-access, location-addressable, file-addressable, and/or content-addressable devices.

It will be appreciated that storage machine 1020 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 1010 and storage machine 1020 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 1000 implemented to perform a particular function. In some cases, a module, program, or engine may be instantiated via logic machine 1010 executing instructions held by storage machine 1020. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 1030 may be used to present a visual representation of data held by storage machine 1020. This visual representation may take the form of a graphical user interface (GUI). As the herein described methods and processes change the data held by the storage machine, and thus transform the state of the storage machine, the state of display subsystem 1030 may likewise be transformed to visually represent changes in the underlying data. Display subsystem 1030 may include one or more display devices utilizing virtually any type of technology. Such display devices may be combined with logic machine 1010 and/or storage machine 1020 in a shared enclosure, or such display devices may be peripheral display devices.

When included, input subsystem 1040 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 1050 may be configured to communicatively couple computing system 1000 with one or more other computing devices. Communication subsystem 1050 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1000 to send and/or receive messages to and/or from other devices via a network such as the Internet.

In one example, a method for annotating images to create a corpus for training a multi-task computer vision machine learning model is presented. The method comprises receiving, at one or more annotation specialist models, a plurality of images to be annotated; via operation of the one or more annotation specialist models, generating pre-filtered annotations for the plurality of images; via operation of a data filtering and enhancement module, filtering the pre-filtered annotations in accordance with predefined noise criteria so as to output candidate annotations for the plurality of images; and for each of one or more candidate annotations, selectively (1) storing the candidate annotation into the corpus as a final annotation for its associated image, or (2) adding the candidate annotation to its associated image using the one or more annotation specialist models and the data filtering and enhancement module for subsequent iterative annotation and filtering. In such an example, or any other example, the one or more annotation specialist models are additionally or alternatively trained models including one or more of a (1) trained caption model; (2) trained grounding model; (3) trained segmentation model; (4) trained object proposal and detection models; and (5) trained optical character recognition model. In any of the preceding examples, or any other example, the filtering of the pre-filtered annotations additionally or alternatively comprises filtering protocols on text data and region data. In any of the preceding examples, or any other example, the filtering protocol on the text data additionally or alternatively includes filtering out texts containing excess objects. In any of the preceding examples, or any other example, the filtering protocol on the text data additionally or alternatively includes retaining texts with a minimum action and object complexity. In any of the preceding examples, or any other example, the filtering protocol on the region data additionally or alternatively includes removing noisy boxes under a confidence score threshold. In any of the preceding examples, or any other example, the filtering protocol on the region data additionally or alternatively includes reducing redundant or overlapping bounding boxes. In any of the preceding examples, or any other example, the method additionally or alternatively comprises employing the trained multi-task computer vision machine learning model to receive one or more images and to iteratively annotate each of the received images.

In another example, a system for training a multi-task computer vision machine-learning model is presented. The system comprises one or more annotation specialist models configured to receive a plurality of images to be annotated; and generate pre-filtered annotations for the plurality of images; a data filtering and enhancement module configured to filter the pre-filtered annotations in accordance with predefined noise criteria so as to output candidate annotations for the plurality of images; an iterative data refinement model configured to iteratively train the multi-task computer vision machine-learning model on the plurality of images annotated by the candidate annotations; and a final annotation module configured to store the candidate annotation into the corpus as a final annotation for its associated image. In such an example, or any other example, the one or more annotation specialist models are additionally or alternatively trained models including one or more of a (1) trained caption model; (2) trained grounding model; (3) trained segmentation model; (4) trained object proposal and detection models; and (5) trained optical character recognition model. In any of the preceding examples, or any other example, the data filtering and enhancement model additionally or alternatively comprises one or more of a (1) text filter; (2) enhancement model, and (3) region filtering model. In any of the preceding examples, or any other example, the final annotations for each associated image additionally or alternatively include at least a brief caption, a detailed caption, and a more detailed caption. In any of the preceding examples, or any other example, the final annotations for each associated image are additionally or alternatively associated with one or more of a detected object and a region of the associated image. In any of the preceding examples, or any other example, the final annotations for each associated image additionally or alternatively include at least a (1) text annotation, (2) region-text pair annotation, and (3) text-phrase-region triplet annotation.

In yet another example, a method for computer vision is presented. The method comprises receiving a first image and a first multi-task prompt related to the first image; encoding the first image; extracting a first set of embeddings from the encoded first image; processing the first set of embeddings and the first multi-task prompt using a sequence-to-sequence architecture operating with a single set of weights and a single loss function; generating a first set of tokens from the processed first set of embeddings and the first multi-task prompt; and outputting a response to the first multi-task prompt based on the first set of tokens. In such an example, or any other example, the method additionally or alternatively comprises receiving a second image and a second multi-task prompt related to the second image; encoding the second image; extracting a second set of embeddings from the encoded second image; processing the second set of embeddings and the second multi-task prompt using the sequence-to-sequence architecture operating with the single set of weights and the single loss function; generating a second set of tokens from the processed second set of embeddings and the second multi-task prompt; and outputting a response to the second multi-task prompt based on the second set of tokens. In any of the preceding examples, or any other example, the method additionally or alternatively comprises receiving a third multi-task prompt related to the first image; processing the first set of embeddings and the third multi-task prompt using the sequence-to-sequence architecture operating with the single set of weights and the single loss function; generating a third set of tokens from the processed first set of embeddings and the third multi-task prompt; and outputting a response to the third multi-task prompt based on the third set of tokens. In any of the preceding examples, or any other example, the sequence-to-sequence architecture additionally or alternatively comprises a transformer encoder and a transformer decoder. In any of the preceding examples, or any other example, the first set of embeddings additionally or alternatively includes one or more of visual embeddings, text embeddings, and location embeddings. In any of the preceding examples, or any other example, the first set of tokens additionally or alternatively includes one or more of text tokens and location tokens.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for annotating images to create a corpus for training a multi-task computer vision machine learning model, comprising:
receiving, at one or more annotation specialist models, a plurality of images to be annotated;
via operation of the one or more annotation specialist models, generating pre-filtered annotations for the plurality of images;
via operation of a data filtering and enhancement module, filtering the pre-filtered annotations in accordance with predefined noise criteria so as to output candidate annotations for the plurality of images; and
for each of one or more candidate annotations, selectively (1) storing the candidate annotation into the corpus as a final annotation for its associated image, or (2) adding the candidate annotation to its associated image using the one or more annotation specialist models and the data filtering and enhancement module for subsequent iterative annotation and filtering.

2. The method of claim 1, where the one or more annotation specialist models are trained models including one or more of a (1) trained caption model; (2) trained grounding model; (3) trained segmentation model; (4) trained object proposal and detection models; and (5) trained optical character recognition model.

3. The method of claim 1, where the filtering of the pre-filtered annotations comprises filtering protocols on text data and region data.

4. The method of claim 3, wherein the filtering protocol on the text data includes filtering out texts containing excess objects.

5. The method of claim 3, wherein the filtering protocol on the text data includes retaining texts with a minimum action and object complexity.

6. The method of claim 3, wherein the filtering protocol on the region data includes removing noisy boxes under a confidence score threshold.

7. The method of claim 3, wherein the filtering protocol on the region data includes reducing redundant or overlapping bounding boxes.

8. The method of claim 1, further comprising:
employing the trained multi-task computer vision machine learning model to receive one or more images and to iteratively annotate each of the received images.

9. A system for training a multi-task computer vision machine-learning model, comprising:
one or more annotation specialist models configured to:
receive a plurality of images to be annotated; and
generate pre-filtered annotations for the plurality of images;
a data filtering and enhancement module configured to:
filter the pre-filtered annotations in accordance with predefined noise criteria so as to output candidate annotations for the plurality of images;
an iterative data refinement model configured to:
iteratively train the multi-task computer vision machine-learning model on the plurality of images annotated by the candidate annotations; and
a final annotation module configured to store the candidate annotation into the corpus as a final annotation for its associated image.

10. The system of claim 9, wherein the one or more annotation specialist models are trained models including one or more of a (1) trained caption model; (2) trained grounding model; (3) trained segmentation model; (4) trained object proposal and detection models; and (5) trained optical character recognition model.

11. The system of claim 9, wherein the data filtering and enhancement model comprises one or more of a (1) text filter; (2) enhancement model, and (3) region filtering model.

12. The system of claim 9, wherein the final annotations for each associated image include at least a brief caption, a detailed caption, and a more detailed caption.

13. The system of claim 12, wherein the final annotations for each associated image are associated with one or more of a detected object and a region of the associated image.

14. The system of claim 13, wherein the final annotations for each associated image include at least a (1) text annotation, (2) region-text pair annotation, and (3) text-phrase-region triplet annotation.

15. A method for computer vision, comprising:
receiving a first image and a first multi-task prompt related to the first image;
encoding the first image;
extracting a first set of embeddings from the encoded first image;
processing the first set of embeddings and the first multi-task prompt using a sequence-to-sequence architecture operating with a single set of weights and a single loss function;
generating a first set of tokens from the processed first set of embeddings and the first multi-task prompt; and
outputting a response to the first multi-task prompt based on the first set of tokens.

16. The method of claim 15, further comprising:
receiving a second image and a second multi-task prompt related to the second image;
encoding the second image;
extracting a second set of embeddings from the encoded second image;
processing the second set of embeddings and the second multi-task prompt using the sequence-to-sequence architecture operating with the single set of weights and the single loss function;
generating a second set of tokens from the processed second set of embeddings and the second multi-task prompt; and
outputting a response to the second multi-task prompt based on the second set of tokens.

17. The method of claim 16, further comprising:
receiving a third multi-task prompt related to the first image;
processing the first set of embeddings and the third multi-task prompt using the sequence-to-sequence architecture operating with the single set of weights and the single loss function;
generating a third set of tokens from the processed first set of embeddings and the third multi-task prompt; and
outputting a response to the third multi-task prompt based on the third set of tokens.

18. The method of claim 15, wherein the sequence-to-sequence architecture comprises a transformer encoder and a transformer decoder.

19. The method of claim 15, wherein the first set of embeddings includes one or more of visual embeddings, text embeddings, and location embeddings.

20. The method of claim 15, wherein the first set of tokens includes one or more of text tokens and location tokens.
